(19) United States
(12) Patent Application Publication
(10) Pub. No.: US 2026/0238498 A1
(43) Pub. Date: Aug. 13, 2026

(54) SECURE KEY-AUTHORIZATION TRANSFER

(71) Applicant: Silvio Micali, Brookline, MA (US)

(72) Inventor: Silvio Micali, Brookline, MA (US)

(21) Appl. No.: 19/054,795

(22) Filed: Feb. 15, 2025

Related U.S. Application Data
(60) Provisional application No. 63/755,645, filed on Feb. 7, 2025.

(51) Int. Cl. H04L 9/32

(52) U.S. Cl. CPC H04L 9/3268; H04L 9/321

(57) ABSTRACT

Issuing a subsequent digital certificate that authorizes a subsequent set of tasks based on a prior digital certificate that authorizes a prior set of tasks includes verifying that a subsequent public key corresponding to the subsequent digital certificate has a same owner as a prior public key corresponding to the prior digital certificate based on information proving that the prior public key and the subsequent public key have the same owner and confirming that authorizing the subsequent set of tasks is appropriate based on the prior set of tasks. The subsequent digital certificate may include a subsequent secret key that corresponds to the subsequent public key that is kept secret from a party issuing the subsequent digital certificate. A party issuing the subsequent digital certificate privately may receive the prior digital certificate and the information proving that the prior public key and the subsequent public key have the same owner.

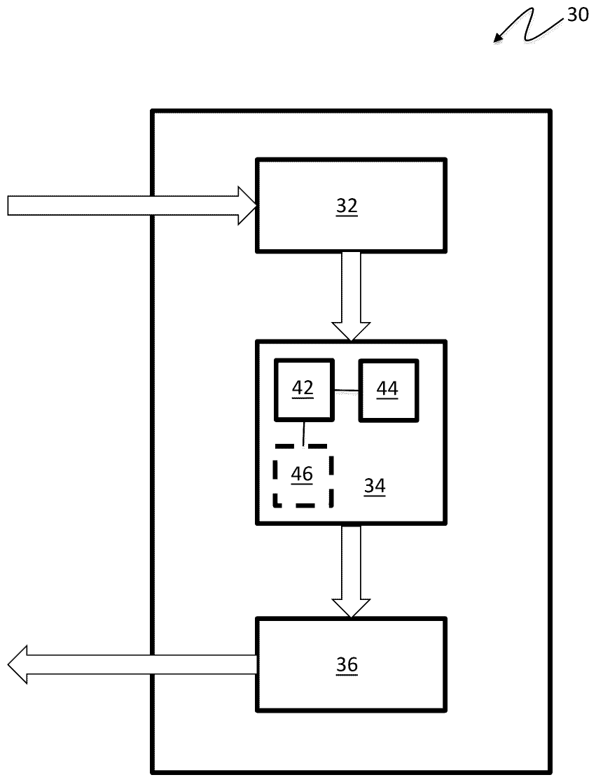

### TECHNICAL FIELD

This application relates to the field of cryptography and more particularly to the field of using cryptography to issue a digital certificate based on a prior digital certificate.

### BACKGROUND OF THE INVENTION

In a digital system, many transactions are executed by public keys. Certain transactions, such as retrieving information from a secret database or trading very sensitive assets, require authorization from a proper authority (i.e., a proper entity). In such instances, it may be necessary to prove that a public key is properly authorized by such an authority to perform a given set of tasks. Digital certificates, which are based on digital signatures, may be used to provide a proof of authorization.

A digital signature of a message (string) m, relative to a public key K, is a string proving to anyone that m has been authenticated by K. Such a signature of m is denoted by SIG_{K}(m). Because only the owner of K—i.e., the entity or the person knowing K's secret key—can compute SIG_{K}(m) on input m, it is possible to identify key K with its owner, O, and write SIG_{O}(m) instead of SIG_{K}(m). In some situations, the message m may be directly computable from SIG_{K}(m). In other instances, the message may not be computable from SIG_{K}(m). For example, it is possible to one-way hash m prior to signing m. That is, SIG_{K}(H(m)) is equated to SIG_{K}(m), where H is a function such that it is hard to find two different strings x and y for which H(x)=H(y). For simplicity, SIG_{K}(m) may be considered shorthand for (m, SIG_{K}(m)), which makes it immediately clear what the signed message is.

A digital certificate is an essential component of the Public Key Infrastructure (PKI), which provides a framework for reliably verifying data. For example, a digital certificate may be used to prove that a given public key PK is authorized by an authority A, owning a public key PK_{A}. The certificate may certify PK together with some additional information ai: for instance, time information, duration of the digital certificate, a set of tasks that are authorized for PK by the certificate, or the empty information (no information). In such a case, the certificate may consist of the signature SIG_{PK}_{_{A}}(PK, ai). When it is not necessary to make such additional information explicit, it is possible to only write SIG_{A}(PK). Such a certificate may be used in any application that knows A's public key, and thus can verify A's digital signatures.

Typically, A issues a certificate for PK after a proper KYC (Know Your Customer) process, conducted by A or another proper entity, so that the certificate vouches that the identity of PK's owner is properly known. This identity information may be explicitly included in the certificate or the identity information may be kept separately (e.g., in a private database), and provided on a need-to-know basis (e.g., in response to a court order).

Sometimes, the verifier of a certificate SIG_{PK}_{_{A}}(PK) may not know PK_{A}, but may know the public key, PK_{B}, of another, possibly higher, authority B that has issued a certificate for PK_{A}, SIG_{B}(PK_{A}). In this case, a certificate for PK may also include (or be accompanied by) SIG_{B}(PK_{A}). Together, SIG_{B}(PK_{A}) and SIG_{A}(PK) may be taken to be a single, compound certificate for PK. This compound certificate can be considered issued by B, A, or both.

Generating Compound Certificates May be Generalized. For Instance,
authority A₁ may issue a certificate SIG_{A}_{₁}(PK_{A}_{₂}),
authority A₂ may issue a certificate SIG_{A}_{₂}(PK_{A}_{₃}),
. . .
Authority Aₖ may issue a certificate SIG_{A}_{ₖ}(PK) for PK.

In this case, the sequence SIG_{A}_{₁}(PK_{A}_{₂}), SIG_{A}_{₂}(PK_{A}_{₃}), . . . , SIG_{A}_{ₖ}(PK) is a compound certificate for PK issued by authority A₁, or any other authority in the chain. Each certificate for PK_{A}_{ᵢ} may of course specify some additional information. For instance, information vouching Aᵢ's ability to issue certificates of a given type.

Compound certificates make it possible for A₁ to certify the public keys of one or more authorities A₂, each of which may certify the public keys of one or more authorities A₃, and so on, until some authority Aₖ issues an ordinary certificate for a public key PK. Accordingly, an authority can verify a compound certificate for PK even if the authority knows in advance only the public key of A₁. Note that the term “certificate” includes an ordinary certificate or a compound certificate.

A problem of authorizing a public key PK from scratch is that a secure authorization process takes time. Such process typically requires KYC (Know Your Customer), because one does not wish to authorize a public key PK but rather, one authorizes an owner O of a public key—i.e., an entity that knows PK's secret key—to perform certain tasks with PK. Thus, the authorization process behind the issuance of a digital certificate for PK includes at least two components:
a) Verifying that O should be authorized for a given set of tasks, and
b) Verifying that O indeed owns PK, that is, that O knowns PK's secret key.

Both components can be complex and time consuming.

The first component may include verifying O's identity, age, past history, employment, net worth, etc., items that may require extensive documentation and in-person presence.

The second component may require a non-trivial effort, too. At least if one wants bullet-proof security. For example, consider the following two ways to verify that 0 is PK's owner.
1. Ask O to provide SIG_{PK}(M) for a standard message M, such as a fixed string or the current date, and verify the received signature. Note that this simple approach does not guarantee that O indeed owns PK. This is because an “unauthorizable” entity E may be the only one to know PK's secret key, and provides SIG_{PK}(M) instead of O.
2. Ask O to provide SIG_{PK}(M) for a message M, randomly chosen during an in-person meeting attended by O with a computing device D, and verify the received signature. Note that this approach may not work either. In fact, D may wirelessly transmit M to E during the meeting, receive SIG_{PK}(M) from E, and provide SIG_{PK}(M) to the verifier. Further note that this approach may not work even if the in-person meeting occurs in a “faraday cage”, that is, in a room preventing any possible wireless connection. This is so because device D may contain a secure chip, provided by E and safekeeping PK's secret key inside, and may erase it after producing SIG_{PK}(M).

A truly secure verification process should be more elaborate. For instance, O could be asked to enter a secure room via a metal detector (so as to ensure that O is not carrying any computing device) carrying at most a piece of paper with PK's secret. In the room O finds a computer, provided by the verifier, preloaded with the digital signature algorithm, minus of course the secret key of PK, that the verifier does not know. At this point, the verifier randomly selects on the spot a random message M, asks O to manually input PK's secret key using the computer's keyboard, and to provide SIG_{PK}(M).

This process is certainly complex. Moreover, it requires that O trusts (a) the verifier's computer not to keep a copy of PK's secret key and (b) the verifier not to observe O while O is typing the secret key.

### SUMMARY OF THE INVENTION

Since securely authorizing a public key PK is complex, it would be useful to invoke public key authorization from scratch as few times as possible. The system described herein minimizes a number of times needed to authorize a public key from scratch. The system described herein allows for an easy and secure transfer of authorization from one public key to another public key with the same owner, avoiding repeating the costly components of an authorization.

According to the system described herein, issuing a subsequent digital certificate that authorizes a subsequent set of tasks based on a prior digital certificate that authorizes a prior set of tasks includes verifying that a subsequent public key corresponding to the subsequent digital certificate has a same owner as a prior public key corresponding to the prior digital certificate based on information proving that the prior public key and the subsequent public key have the same owner and confirming that authorizing the subsequent set of tasks is appropriate based on the prior set of tasks. The subsequent digital certificate may include a subsequent secret key that corresponds to the subsequent public key that is kept secret from a party issuing the subsequent digital certificate. A party issuing the subsequent digital certificate may privately receive the prior digital certificate and the information proving that the prior public key and the subsequent public key have the same owner. The information proving that the prior public key and the subsequent public key have the same owner may be kept secret from an external observer. The information proving that the prior public key and the subsequent public key have the same owner may include a digital signature relative to the prior public key that is kept private after issuing the subsequent digital certificate. The information proving that the prior public key and the subsequent public key have the same owner may be conditionally revealed after being kept private.

According further to the present invention, a digital certificate authorization system includes a receiver that receives a prior public key corresponding to a prior digital certificate that authorizes a prior set of tasks and receives information indicating that the prior public key and a subsequent public key corresponding to a proposed subsequent digital certificate that authorizes a subsequent set of tasks have a same owner, a cryptographic system having at least one processor and a non-transitory computer readable medium containing software that determines an authorization of the subsequent digital certificate based on verifying the information indicating that the prior public key and the subsequent public key have the same owner and on the subsequent set of tasks being appropriate given the prior set of tasks, and a transmitter that transmits the authorization of the subsequent digital certificate. The subsequent digital certificate may include a subsequent secret key corresponding to the subsequent public key and the authorization may be provided without accessing the subsequent secret key. The digital certificate authorization system may privately receive the prior digital certificate and the information proving that the prior public key and the subsequent public key have the same owner. The information proving that the prior public key and the subsequent public key have the same owner may be kept secret from an external observer. The information proving that the prior public key and the subsequent public key have the same owner may include a digital signature relative to the prior public key that is kept private after issuing the subsequent digital certificate. The information proving that the prior public key and the subsequent public key have the same owner may be conditionally revealed after being kept private.

According further to the system described herein, issuing a subsequent digital certificate that authorizes a subsequent set of tasks based on a prior digital certificate that authorizes a prior set of tasks includes receiving the prior digital certificate, receiving information that is easier to compute with knowledge of a prior secret key that corresponds to a prior public key of the prior digital certificate than without knowledge of the prior secret key, the information causing a subsequent secret key that corresponds to a subsequent public key of the subsequent digital certificate to be easier to compute from the prior secret key without revealing either of the secret keys, where the prior public key and the subsequent public key appear unrelated to an external observer, and authorizing the subsequent digital certificate in response to verifying the information and on verifying that authorizing the subsequent set of tasks is appropriate based on the prior set of tasks. The secret key of the subsequent public key is kept secret from a party that authorizes the subsequent digital certificate. A party that authorizes the subsequent digital certificate may maintain as secret from an external observer how to determine the secret key of the subsequent public key using the secret key of the prior public key. The party may receive a proof indicating that the subsequent secret key can be determined based on knowledge of the prior secret key, the proof including a digital signature relative to the prior secret key, where the proof is kept private after issuing the subsequent digital certificate. The proof may be conditionally revealed after being kept private.

According further to the system described herein, a digital certificate authorization system includes a receiver that receives a prior digital certificate and receives information that is easier to compute with knowledge of a prior secret key that corresponds to a prior public key of the prior digital certificate than without knowledge of the prior secret key, the information causing a subsequent secret key that corresponds to a subsequent public key of a subsequent digital certificate to be easier to compute from the prior secret key without revealing either of the secret keys, wherein the prior public key and the subsequent public key appear unrelated to an external observer. The a digital certificate authorization system also includes a cryptographic system having at least one processor and a non-transitory computer readable medium containing software that authorizes the subsequent digital certificate in response to verifying the information and on verifying that authorizing the subsequent set of tasks is appropriate based on the prior set of tasks and a transmitter that transmits the authorization of the subsequent digital certificate. The authorization may be provided without accessing the subsequent secret key. How to determine the secret key of the subsequent public key using the secret key of the prior public key may be maintained as secret from an external observer. The receiver may receive a proof indicating that the subsequent secret key can be determined based on knowledge of the prior secret key, the proof including a digital signature relative to the prior secret key, wherein the proof is kept private after issuing the subsequent digital certificate. The proof may be conditionally revealed after being kept private.

Let C=SIG_{A}(PK, ai) be a digital certificate, issued by an authority A, vouching that PK is authorized for a first set of tasks. The system described herein leverages the verification effort invested in producing C, to securely and efficiently obtain a new digital certificate C′=SIG_{A′}(PK′, ai′) for a new public key PK′, issued by an authority A′, vouching that PK′ is authorized for a second set of tasks specified in ai′. Specifically, leveraging the verification effort invested in producing C and issuance of C′ is achieved by
(1) A′ receiving the certificate C for PK and information proving that PK and PK′ have the same owner;
(2) A′ verifying the certificate and the correctness of the received information
(3) A′ verifying that it is proper to issue a certificate with additional information ai′ for PK′ based on the addition information ai in the certificate C, and
(4) If all the above verification is passed, A′ issuing the certificate C′ for PK′.

### Furthermore, the System Described Herein Provides Two Additional Privacy Properties:

P₁. The secret key of PK′ is kept secret from A and A′; and
P₂. The information that PK and PK′ have the same owner is kept secret to an external observer, someone who is not A′ or an owner of PK and PK′.

For the discussion above, note that A and A′ may or may not be the same entities, PK and PK′ may or may not be the same keys, and ai and ai′ may or may not be equal.

The following examples illustrate different scenarios for issuing certificate C′ given certificate C. As a first example, C authorizes a set of authorized tasks for PK that is a subset of the set of tasks authorized by C′ for PK′; and the expiration date of C′ does not exceed that of C. In such a case, the issuance of such C′ may be requested by the owner of PK for privacy reasons because, for example, the identity of the owner is compromised from a long transactional history with the same public key.

As a second example, the second set of authorized tasks for C′ may include particular tasks authorized for C and additional tasks, because, for example, it is a policy to grant the ability to perform additional tasks for any public key already authorized for the particular tasks.

As for a third example, the tasks authorized by C and C′ may be the same, but the expiration date of C′ exceeds that of C, as to “renew” the authorizations of PK, when PK=PK′, or as to extend the authorizations enjoyed by the owner of PK, but transfer the authorizations to a new public key PK′ of the owner.

The following clarifications are useful for the discussion that follows:

COMMUNICATION. The transmission of a message (datastring) x from a party A to a party B may occur in very different ways. For instance,
A may send x directly to B.
A may send x to an intermediary who then sends x to B. This transmission can use multiple intermediaries as well. For example, via so-called onion routing.
A may cause x to be posted in a repository accessible to B. For instance, A may cause x to be posted on a blockchain readable by B.
A may transmit x to B using a combination of ways. For example, A may send a first portion of x directly to B; send a second portion of x to someone else, who then transmits the second portion of x to B; and post a third portion of x in a repository accessible to B.

More generally, “A transmits x to B” means that A causes x to be received by B. When A transmits x to B, B receives x from A.

The transmission by A of x to B is private if no one else learns x. For instance, without any limitation intended, A may transmit x encrypted in a way that is understandable by B, over a secure channel linking A and B, or in person.

VERIFICATION. A party A verifies a piece of information x by any of the following: A verifies x itself; another party B verifies x and causes A to be informed that x has been verified; different parties (possibly including A) verify different parts of x and cause A to be informed that each part of x has been verified.

PROOF OF SAME OWNERSHIP. A third additional property, property P₃, is that authority A′ receives a proof that the owner of PK is indeed also the owner of PK′. The proof may initially be kept private, and then possibly revealed to proper parties, if proper circumstances arise.

### BRIEF DESCRIPTION OF DRAWINGS

Embodiments of the system described herein will now be explained in more detail in accordance with the FIGURES of the drawings, which are briefly described as follows.

The sole FIGURE illustrates a digital certificate authorization system according to an embodiment of the system described herein.

### DETAILED DESCRIPTION OF VARIOUS EMBODIMENTS

Different scenarios are presented below to illustrate the system described herein. In all the scenarios below, the owner O of PK transmits some information to A′ with an implicit request that, after verifying the received information, A′ issues a certificate C′=SIG_{A′}(PK′, ai′).

Scenario 1. O transmits to A′
1. the certificate issued by A, C=SIG_{A}(PK, ai) and
2. the key PK′.

This scenario is insecure. Indeed, an impostor Ĩ may get hold of C and present C to A′, without O's knowledge, together with a key \tilde{P}K chosen by Ĩ. In this case, O only knows the secret key of PK and only Ĩ knows the secret key of \tilde{P}K. Yet, Ĩ will be able to obtain from A′ a certificate \tilde{C} for \tilde{P}K enabling Ĩ to execute tasks for which Ĩ is not at all authorized. Consider, therefore, the following modification of Scenario 1.

Scenario 2. O transmits A′
1. the certificate issued by A, C=SIG_{A}(PK, ai),
2. a key PK′, and
3. SIG_{PK}(PK′, ai′).

Scenario 2 is also insecure. Although Scenario 2 may guarantee that O takes responsibility for PK′, Scenario 2 does not guarantee that O knows the secret key of PK′. Indeed, an impostor I may cause O (e.g., by bribing O) to transmit information items 1 through 3 to A′, but for a key PK′ whose secret key is known to I but not to O. In this case, impostor I will obtain from A′ a certificate for PK′ which I can use for all kinds of activities: for example, accessing a secret database for which/is not at all authorized.

Note that, in a fully automated setting, such foul play may not be discovered. And even if the foul play were discovered, it is possible to punish O, but this is a small consolation if I had already learned the entire database anyway.

### Scenario 3. O Transmits A′ Information Items 1 Through 3 as Before, but Also

4. SIG_{PK′}(M), the signature of PK′ for a standard message M or a message M selected by A′, or another entity, on the spot.

Information item 4 intends to reassure A′ that whoever requests a certificate C′ for PK′ indeed knows the secret key of PK′. Indeed, SIG_{PK′}(M) is a proof of knowledge of the secret key of PK′. The problem with this approach, however, is that the provider of this proof, and thus the one who knows the secret key of PK′, may not be the same entity knowing the secret key of PK. Therefore, an impostor I may cause O (e.g., by bribing O) to transmit to A′ information items 1 through 3, as before, together with information item 4 provided by I. Once more, therefore, impostor I will obtain from A′ a certificate for PK′ which impostor I can use for all kinds of activities for which impostor I is not at all authorized.

Note that Scenario 3 would remain insecure even if information item 4 consisted of the very secret key of PK′ instead of SIG_{PK′}(M). In fact, such a secret key could be provided by I and be unknown to O.

### Scenario 4. O Transmits Information Items 1 Through 3, as in Scenario 3, but Also

4. The secret key of PK′ and
5. SIG_{PK}(X), where X consists of information items 1 through 4.

Scenario 4 is insecure in two ways.

First, because items 1-4 are longer than a messages PK can sign, and therefore item 5 will consist of SIG_{PK}(H(X)). Accordingly, once more, an impostor I could cause O (e.g., by bribing O) to sign H(X) without revealing to O the secret key of PK′. Indeed, I need just to give O the hash value H(X) which hides X and thus item 4. In sum, once again, the information presented to A′ does not guarantee that the owner of PK′ is the same owner of PK. Thus, I can obtain from A′ a certificate for PK′ which I can use for all kinds of activities for which I is not authorized.

The other insecurity for Scenario 4 relates to the fact that O does not want to reveal the secret key of PK′ to A′. Indeed, generally each actor should take responsibility for items that each actor willingly signs and should not enable an entity to impersonate another entity.

The system described herein addresses deficiencies described in the various scenarios set forth above. In the system described herein, owner O transmits to A′, preferably in a private and authenticated manner, at least some of the following pieces of information:
1. the certificate issued by A, C=SIG_{A}(PK, ai),
2. a key PK′,
3. possibly, SIG_{PK}(PK′, ai′),
4. information s′ that is guaranteed to
   (i) be hard to compute without knowledge of PK's secret key,
   (ii) make the secret key of PK′ easily computable from the secret key of PK,
   (iii) not reveal the secret keys of PK or PK′, and
   (iv) make PK′ unrelated to PK to an external observer
5. possibly additional information.

Upon receiving a transmission indicated by items 1-5, above, authority A′ verifies that the relevant transmitted information is correct. For instance, A′ may verify that the digital signature of A authenticating certificate C is correct;
A is indeed authorized to issue C;
It is proper to issue C′ given C;
s′ is computable by the owner of PK; and
s′ indeed implies that PK and PK′ have the same owner.

If the verification set forth above is passed, then A′ issues the certificate C′=SIG_{A′}(PK′, ai′).

### In Sum, as Described Elsewhere Above,

(1) A′ receives the certificate C for PK and the information s′ that proves that PK and PK′ have the same owner;
(2) A′ verifies C and the correctness of s′.
(3) A′ verifies that a certificate with additional information ai′ is issuable for PK′ by verifying that the set of authorized tasks specified by ai′ is proper given those specified by ai.
(4) If all the above verification is passed, A′ issuing the certificate C′ for PK′.

Referring to the sole FIGURE, a digital certificate authorization system 30 includes a receiver 32, a cryptographic system 34, and a transmitter 36. The receiver 32 receives data that is used by the digital certificate authorization system to authorize digital certificates as described herein. The digital certificate authorization system 30 may be implemented using a plurality of interconnected servers located at the same facility, located in different facilities, or some combination thereof. In some embodiments, components of the digital certificate authorization system 30 (e.g., the receiver 32, the cryptographic system 34, and the transmitter 36) may be placed within a secure perimeter that protects the components and communications between the components from malicious actors that may try to obtain data from the digital certificate authorization system 30 in an unauthorized manner. The secure perimeter maintains privacy for the digital certificate authorization system 30. The secure perimeter may be a physical perimeter, a logical/cryptographic perimeter (e.g., data encryption), or a combination of both.

The receiver 32 may receive data that is used by the digital certificate authorization system 30 to provide authorization for digital certificates. The receiver 32 may receive, for example, a prior (initial) digital certificate, a prior public key corresponding to the prior digital certificate, information indicating that the prior public key and a subsequent public key corresponding to a proposed subsequent digital certificate that authorizes a subsequent set of tasks have a same owner, and/or information that is easier to compute with knowledge of the prior secret key than without knowledge of the prior secret key. Similarly, the transmitter 36 transmits data from the digital certificate authorization system 30, including transmitting an authorization for a subsequent digital certificate that is based on the prior digital certificate as described elsewhere herein.

The cryptographic system 34 transforms data that is received from the receiver 32 and to provide data to the transmitter 36. The cryptographic system 34 includes one or more processors 42 coupled to a non-transitory computer readable medium containing software that, where executed by the processor 42, provides the functionality described herein. In some embodiments, the cryptographic system 34 may include a secret key 46 that is different and separate from any secret keys used by any digital certificates handled by the cryptographic system 34. The secret key 46 may be used by the processor 42 to provide a digital signature of the digital certificate authorization system 30 so that, in some cases, the authorization provided by the digital certificate authorization system 30 is a digital signature of specific data (described elsewhere herein) where the digital signature is provided using the secret key 46.

It is possible to show, in a step-by-step manner, that A′ is provided the right amount of information to verify that PK and PK′ have the same owner. Specifically:
(a) The certificate C vouches that PK's owner knows PK's secret key.
(b) Only the owner of PK can easily compute s′, because of property 4(i).
(c) The owner of PK can easily compute the secret key of PK′, because the owner of PK can compute s′ by property 4(i), and because s′ yields the secret key of PK′ by 4 (ii).

Thus, the owner of PK also owns PK′.

Notice that property 4 (iii), above, guarantees that the secret key of PK′ is kept secret from A′. This occurs because the information received by A′ consists of s′ and public information such as public information contained in the certificate C, the public key PK′, and possibly SIG_{PK}(PK′, ai′).

Also notice that property 4 (iv), above, guarantees that PK′ looks unrelated to PK to an external observer since A′ does not receive s′.

Several digital signature schemes are based on the discrete-log problem, over the multiplicative group modulo a prime number p, Z*ₚ; a proper elliptic curve; etc.

In such groups, it is easy to compute g^{e} from g and e. It is also easy to compute a₁·a₂ for any choice of a₁ and a₂. (Moreover, if a₁=g^{e}^{₁} and a₂=g^{e}^{₂}, then a₁·a₂=g^{e}^{₁}^{+e}^{₂}.) However, it is not possible to efficiently compute e from g and g^{e}.

Accordingly, in discrete-log based digital signature schemes, one chooses a public parameter g (e.g., a generator) and a public key-secret key pair consists of a pair (g^{e}, e).

The discussion below illustrates how the owner O of a public key PK=g^{x}, authorized by a certificate C=SIG_{A}(PK, ai), obtains a new certificate C′=SIG_{A′}(PK′, ai′).

Owner O, given a value r′,
chooses the information s′ to be s′=SIG_{PK}(r′);
sets PK′=g^{x+H(s′)}, so that a secret key for PK′ is x+H(s′)—where H is a cryptographic hash function (which de facto turns any input x into a random number H(x)).
transmits to A′: C, PK′, SIG_{PK}(PK′, ai′), s′—and possibly additional information.
   The Transmission May be Private. In Turn, A′ Verifies that
(a) the digital signature of A authenticating certificate C is correct,
(b) A is indeed authorized to issue C,
(c) the set of authorized tasks specified by ai′ is proper, given ai,
(d) s′ is computable by the owner of PK, by verifying that s′ is the signature of r′ relative to the public key g^{x}; and
(e) s′ implies that PK and PK′ have the same owner, by easily computing
   H(s′) from s′
   g^{H(s′)} from H(s′), and
   PK·g^{H(s′)} from PK and g^{H(s′)} and then verifying that
   PK′=PK·g^{H(s′)}.
      If the verifications succeed, then A′ issues the certificate C′=SIG_{A′}(PK′, ai′).

It is possible to show, in three steps, that, if A′ issues C′, then an owner O of PK=g^{x} is also an owner of PK′=g^{x+H(s′)}.

Recall that an owner of a public key is an entity that knows a secret key that corresponds to the public key.
STEP 1:0 knowing the secret key of PK is certified by the certificate C that A′ has verified to be valid. Since PK=g*, O knows x.
STEP 2:0 knows s′, because O can easily compute s′=SIG_{PK}(r′) on demand and the appropriate signature can only be generated by an owner of PK.
STEP 3: An entity that knows x and s′ can compute x+H(s′), which is the secret key of PK′.

Thus, knowledge of PK's secret key enables one to easily compute the secret key of PK′.

Note that the message r′ can be selected arbitrarily. For instance, the message r′ can be selected at random, and sufficiently long, each time it is desired to authorize a new key PK′ based on the certificate of PK. This way, with overwhelming probability, PK′ will be a key that has never been used before. As for another example, to authorize an ith new key, PKᵢ′, it is possible to use the datastring s′ᵢ=SIG_{PK}(“new key number i”).

It can be shown that the secret key of PK′ is kept secret from A′ so that A′ can not learn the secret key of PK′ from information received by A′. Indeed, the information received by A′ consists of: C, PK′, SIG_{PK}(PK′, ai′), and s′=SIG_{PK}(r′); thus, none of the received information reveals the secret key of PK′. In fact, the secret key of PK′ consists of x+H(s′) and thus is unknown to A′, since A′ may compute H(s′) but has no idea of what x is. Indeed x is the secret key of PK=g^{x}.

It can be shown that the information that PK and PK′ have a same owner is kept secret from an external observer. Such an observer sees PK and PK′ but not s′ or H(s′). Thus, the external observer cannot even tell that PK and PK′ are related in any special way. The relation of PK and PK′ is that PK′=PK·g^{H(s′)}. The external observer can, like anyone else, compute

$$\frac{{PK}^{′}}{PK}$$

but cannot tell that the result is special in any way, let alone that the result coincides with g^{H(s′)} since the external observer does not know s′ or H(s′).

Note that s′ is a proof, actually consisting of a digital signature of PK, that PK and PK′ have the same owner. Such a proof can be initially privately stored, by A′ or someone else, and, if necessary, revealed to proper parties (e.g., to investigators with a court order). That is, the proof may be conditionally revealed and, if the condition(s) are not met, never revealed at all.

Various embodiments discussed herein may be combined with each other in appropriate combinations in connection with the system described herein. Additionally, in some instances, the order of steps in the flowcharts, flow diagrams and/or described flow processing may be modified, where appropriate. Subsequently, system configurations may vary from the illustrations presented herein. Further, various aspects of the system described herein may be deployed on any appropriate processing device using one or more use operating system(s) suitable for providing the functionality described herein, including, without limitation, an operating system selected from the group consisting of: IOS, Android OS, Windows, Blackberry OS and Linux OS. Certain components of the system may be cloud based.

Software implementations of the system described herein may include executable code that is stored in a computer readable medium and executed by one or more processors. The computer readable medium may be non-transitory and include a computer hard drive, ROM, RAM, flash memory, portable computer storage media such as a CD-ROM, a DVD-ROM, a flash drive, an SD card and/or other drive with, for example, a universal serial bus (USB) interface, and/or any other appropriate tangible or non-transitory computer readable medium or computer memory on which executable code may be stored and executed by a processor. The software may be bundled (pre-loaded), installed from an app store or downloaded from a location of a network operator. The system described herein may be used in connection with any appropriate operating system.

Other embodiments of the invention will be apparent to those skilled in the art from a consideration of the specification or practice of the invention disclosed herein. It is intended that the specification and examples be considered as exemplary only, with the true scope and spirit of the invention being indicated by the following claims.

What is claimed is:

1. A method of issuing a subsequent digital certificate that authorizes a subsequent set of tasks based on a prior digital certificate that authorizes a prior set of tasks, comprising:
verifying that a subsequent public key corresponding to the subsequent digital certificate has a same owner as a prior public key corresponding to the prior digital certificate based on information proving that the prior public key and the subsequent public key have the same owner; and
confirming that authorizing the subsequent set of tasks is appropriate based on the prior set of tasks.

2. The method of claim 1, wherein the subsequent digital certificate includes a subsequent secret key that corresponds to the subsequent public key that is kept secret from a party issuing the subsequent digital certificate.

3. The method of claim 1, wherein a party issuing the subsequent digital certificate privately receives the prior digital certificate and the information proving that the prior public key and the subsequent public key have the same owner.

4. The method of claim 1, wherein the information proving that the prior public key and the subsequent public key have the same owner is kept secret from an external observer.

5. The method of claim 4, wherein the information proving that the prior public key and the subsequent public key have the same owner includes a digital signature relative to the prior public key that is kept private after issuing the subsequent digital certificate.

6. The method of claim 5, wherein the information proving that the prior public key and the subsequent public key have the same owner is conditionally revealed after being kept private.

7. A digital certificate authorization system, comprising:
a receiver that receives a prior public key corresponding to a prior digital certificate that authorizes a prior set of tasks and receives information indicating that the prior public key and a subsequent public key corresponding to a proposed subsequent digital certificate that authorizes a subsequent set of tasks have a same owner;
a cryptographic system having at least one processor and a non-transitory computer readable medium containing software that determines an authorization of the subsequent digital certificate based on verifying the information indicating that the prior public key and the subsequent public key have the same owner and on the subsequent set of tasks being appropriate given the prior set of tasks; and
a transmitter that transmits the authorization of the subsequent digital certificate.

8. The digital certificate authorization system of claim 7, wherein the subsequent digital certificate includes a subsequent secret key corresponding to the subsequent public key and wherein the authorization is provided without accessing the subsequent secret key.

9. The digital certificate authorization system of claim 7, wherein the digital certificate authorization system privately receives the prior digital certificate and the information proving that the prior public key and the subsequent public key have the same owner.

10. The digital certificate authorization system of claim 7, wherein the information proving that the prior public key and the subsequent public key have the same owner is kept secret from an external observer.

11. The digital certificate authorization system of claim 10, wherein the information proving that the prior public key and the subsequent public key have the same owner includes a digital signature relative to the prior public key that is kept private after issuing the subsequent digital certificate.

12. The digital certificate authorization system of claim 11, wherein the information proving that the prior public key and the subsequent public key have the same owner is conditionally revealed after being kept private.

13. A method of issuing a subsequent digital certificate that authorizes a subsequent set of tasks based on a prior digital certificate that authorizes a prior set of tasks, comprising:
receiving the prior digital certificate;
receiving information that is easier to compute with knowledge of a prior secret key that corresponds to a prior public key of the prior digital certificate than without knowledge of the prior secret key, the information causing a subsequent secret key that corresponds to a subsequent public key of the subsequent digital certificate to be easier to compute from the prior secret key without revealing either of the secret keys, wherein the prior public key and the subsequent public key appear unrelated to an external observer; and
authorizing the subsequent digital certificate in response to verifying the information and on verifying that authorizing the subsequent set of tasks is appropriate based on the prior set of tasks.

14. The method of claim 13, wherein the secret key of the subsequent public key is kept secret from a party that authorizes the subsequent digital certificate.

15. The method of claim 13, wherein a party that authorizes the subsequent digital certificate maintains as secret from an external observer how to determine the secret key of the subsequent public key using the secret key of the prior public key.

16. The method of claim 15, wherein the party receives a proof indicating that the subsequent secret key can be determined based on knowledge of the prior secret key, the proof including a digital signature relative to the prior secret key, wherein the proof is kept private after issuing the subsequent digital certificate.

17. The method of claim 16, wherein the proof is conditionally revealed after being kept private.

18. A digital certificate authorization system, comprising:
a receiver that receives a prior digital certificate and receives information that is easier to compute with knowledge of a prior secret key that corresponds to a prior public key of the prior digital certificate than without knowledge of the prior secret key, the information causing a subsequent secret key that corresponds to a subsequent public key of a subsequent digital certificate to be easier to compute from the prior secret key without revealing either of the secret keys, wherein the prior public key and the subsequent public key appear unrelated to an external observer;
a cryptographic system having at least one processor and a non-transitory computer readable medium containing software that authorizes the subsequent digital certificate in response to verifying the information and on verifying that authorizing the subsequent set of tasks is appropriate based on the prior set of tasks; and
a transmitter that transmits the authorization of the subsequent digital certificate.

19. The digital certificate authorization system of claim 18, wherein the authorization is provided without accessing the subsequent secret key.

20. The digital certificate authorization system of claim 18, wherein how to determine the secret key of the subsequent public key using the secret key of the prior public key is maintained as secret from an external observer.

21. The digital certificate authorization system of claim 20, wherein the receiver receives a proof indicating that the subsequent secret key can be determined based on knowledge of the prior secret key, the proof including a digital signature relative to the prior secret key, wherein the proof is kept private after issuing the subsequent digital certificate.

22. The digital certificate authorization system of claim 21, wherein the proof is conditionally revealed after being kept private.
